(19) United States
(12) Patent Application Publication
(10) Pub. No.: US 2008/0157537 A1
(43) Pub. Date: Jul. 3, 2008

(54) Hydraulic pneumatic power pumps and station

(76) Inventor: Danny J. Richard, Sulphur, LA (US)

Correspondence Address: JAMES RAY & ASSOCIATES, 2640 Pitcairn Road, Monroeville, PA, 15146, US

(21) Appl. No.: 12/001,899

(22) Filed: Dec. 13, 2007

Related U.S. Application Data
(60) Provisional application No. 60/856,567, filed on Dec. 13, 2006.

(51) Int. Cl. H02K 7/18; F03G 7/00

(52) U.S. Cl. 290/1 R; 290/54; 290/50

(57) ABSTRACT

An apparatus for generating electrical energy from a vehicle traversing a predetermined section of a roadway. A platform member is disposed on such section of roadway and a plurality of air bags are disposed between the platform and the road surfaces. The air bags are compressed as the vehicles passes over the platform and the compressed air is collected in a storage tank and fed to a generator for generating electrical power. There are also a plurality of coils and magnets disposed between such platform and road surface. The magnets pass through the coils when a vehicle passes over the platform to generate electricity. The electricity is stored in a DC storage unit and later converted to Ac in a DC/AC converter. The electricity generated by both means is delivered to a power distribution system.

### CROSS REFERENCE TO RELATED APPLICATIONS

This application is closely related to and claims benefit from U.S. Provisional Application Ser. No. 60/856,567 filed Dec. 13, 2006.

### FIELD OF THE INVENTION

The present invention relates, in general, to hydraulic pneumatic power pumps, and, more particularly, the present invention relates to a new method for gathering and using energy from an untapped source.

### BACKGROUND OF THE INVENTION

Renewable energy sources will eventually become exhausted and current research and development of alternate sources of energy require the creation from which such energy will be created. These renewable energy sources basically refer to energy sources that are based on the burning of fossil fuels or the splitting of atoms. Not only are these sources becoming exhausted but there is renewed interest in the development of alternative sources because of the undesirable effects of pollution (as witnessed today) both from burning fossil fuels and from nuclear waste byproducts. Some alternative sources that are presently being examined are wind power, in which wind is harnessed through windmills; solar power, in which the sun's energy is used on a smaller scale to generate usable energy to heat homes and heat swimming pools; even the power of tides can be used to create energy.

With the present concern for global warming there is a need to harness energy from as many of these alternative sources as possible. Thus, it would be advantageous if there were a means other than those mentioned that could be used to produce an alternative source of energy.

### SUMMARY OF THE INVENTION

In a first aspect the present invention provides an apparatus for generating electrical energy as a vehicle traverses a predetermined section of a roadway. The apparatus comprises a platform member disposed over such predetermined section of roadway. A biasing means is disposed between a top surface of such roadway and a bottom surface of the platform member for returning the platform member to a raised position after such vehicle has passed over the platform. A plurality of coils are engageable with and disposed in a predetermined pattern on an upper surface of such predetermined section of such roadway and are engageable with and disposed beneath the platform member. A plurality of magnets are engageable with the bottom surface of the platform member, each magnet member of such plurality of magnets is disposed to pass through an interior portion of a respective one of each coil of the plurality of coils when the platform member is depressed by such vehicle traversing the platform member and rising up through the each coil of such plurality of coils when such vehicle has passed and the platform member returns to its original position thereby creating an electrical charge. There is a DC storage unit disposed closely adjacent the platform member and has a first electrical connection with the plurality of coils for storing such DC current created by the plurality of magnets passing through such plurality of coils. A DC to AC converter, having a second electrical connection with the DC storage unit, is disposed closely adjacent the DC storage unit for converting such DC current generated by the plurality of coils and converting such DC current to AC current and a third electrical connection means runs from the DC to AC converter to a power distribution system for delivering electrical power generated by the plurality of coils to such power distribution system.

In a second aspect the present invention provides an apparatus for generating electrical energy as a vehicle traverses a predetermined section of a roadway. The apparatus comprises a plurality of air bags that are engageable with and disposed on an upper surface of such roadway in a predetermined pattern to be compressed by such vehicle. A compressed air storage tank is disposed closely adjacent such roadway and a first fluid communication means is connected at a first end to each of the plurality of air bags and at a second end to the storage tank for communicating compressed air from the air bags to the storage tank. A platform member is engageable with and disposed over the plurality of air bags for such vehicle to pass over thereby causing the plurality of air bags to be compressed and communicate such air to the storage tank. A biasing means is disposed between such top surface of such roadway and a bottom surface of the platform member to return such platform member to a raised position after such vehicle has passed over the platform member and thereby allow the air bags to return to a working position. A first check valve means is disposed in the first fluid communication means, such first check valve means being open to the storage tank as such vehicle is compressing the platform member and in a closed position when such vehicle has passed over the platform member. A second check valve member is connected at a first end thereof to the first fluid communication means and is disposed in fluid communication at a second end thereof to atmosphere such that the second valve means is in a closed position as such vehicle is traversing the platform member and in an open position after such vehicle has passed over the platform member. An electrical generator is disposed closely adjacent the air storage tank and a second fluid communication means is connected at a first end thereof to the storage tank and at a second end thereof to the electrical generator for communicating sufficient air thereto to generate electrical power; and there is a connection from the electrical generator to a power distribution system for delivering power generated by the electrical generator to such power distribution system.

In yet another aspect of the invention there is provided an apparatus for generating electrical energy as a vehicle traverses a predetermined section of a roadway. The apparatus comprises a plurality of hydraulic pumps engageable with and disposed on an upper surface of such roadway in a predetermined pattern to be compressed by such vehicle. A hydraulic motor is disposed closely adjacent said predetermined section of such roadway and a first hydraulic fluid communication means is connected at a first end to each of the plurality of hydraulic pumps and at a second end to the hydraulic motor for communicating hydraulic fluid from the hydraulic pumps to the hydraulic motor. A platform member is disposed over the plurality of hydraulic pumps for such vehicle to pass over thereby causing the plurality of hydraulic pumps to be compressed and communicate the hydraulic fluid to the hydraulic motor. A biasing means is disposed between such top surface of such roadway and a bottom surface of the platform member for returning the platform member to a raised position after such vehicle has passed over the platform member and thereby allow the hydraulic pumps to return to a working position. An electric generator is disposed closely adjacent the hydraulic motor, wherein the hydraulic motor forces such hydraulic fluid into the electric generator while such vehicle is traversing the platform member and stops after such vehicle has passed the platform member and a spring disposed within the hydraulic motor reverses the flow of such hydraulic fluid thereby refilling the hydraulic pumps. A second hydraulic fluid communication means is connected at a first end thereof to the hydraulic motor and at a second end thereof to the electric generator for communicating the hydraulic fluid thereto for generating electrical power. There is an electrical connection from the electrical generator to a power distribution system for delivering power generated by the electrical generator to such power distribution system.

### OBJECTS OF THE INVENTION

It is, therefore, one of the primary objects of the present invention to provide an alternative source of energy.

Another object of the present invention is to provide an alternative source of energy that creates useable energy from moving motor vehicles.

Still another object of the present invention is to provide an alternative source of energy in which the gathering, distributing and using this energy is simple.

Yet another object of the present invention is to provide an alternative source of energy that is cost and time effective.

Another object of the present invention is to provide an alternative source of energy that generates electrical energy from pneumatic means.

Still another object of the present invention is to provide an alternative source of energy that generates electrical energy from a magnet passing through a coil.

It is another object of the present invention to provide an alternative source of energy that generates electrical energy from hydraulic means.

In addition to the various objects and advantages of the invention which have been described in some specific detail above it should be noted that various other objects and advantages of the present invention will become more readily apparent- to those persons who are skilled in the relevant art from the following more detailed description, particularly when such description is taken in conjunction with the appended claims.

### BRIEF DESCRIPTION OF THE DRAWINGS

FIG. 1 is a side perspective view of the platform that is disposed over a road surface according to an embodiment of the invention.

FIG. 2 is a perspective view of the air bags and coils disposed between the platform and the road surface according to an embodiment of the invention.

FIG. 3 is a perspective view of the air bags and biasing means disposed between the platform and the road surface according to an alternate embodiment of the invention.

FIG. 4 is a perspective view of the compressed air storage tank, the DC storage unit, the DC/AC converter and the generator according to an embodiment of the invention.

FIG. 5 is a perspective view of the magnet disposed so as to pass within the coils according to an embodiment of the invention.

FIG. 6 is a block diagram showing the flow pattern of the electricity generated by the magnets and coils, the pneumatic system and the hydraulic system for generating electricity.

FIG. 7 is a perspective view of the hydraulic system according to an alternate embodiment of the invention.

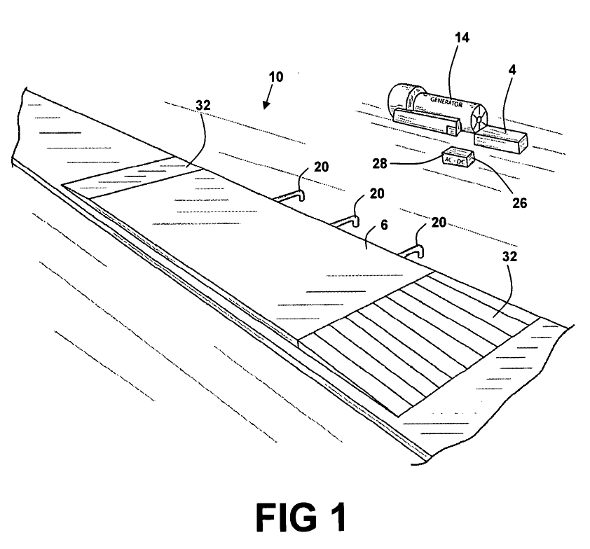

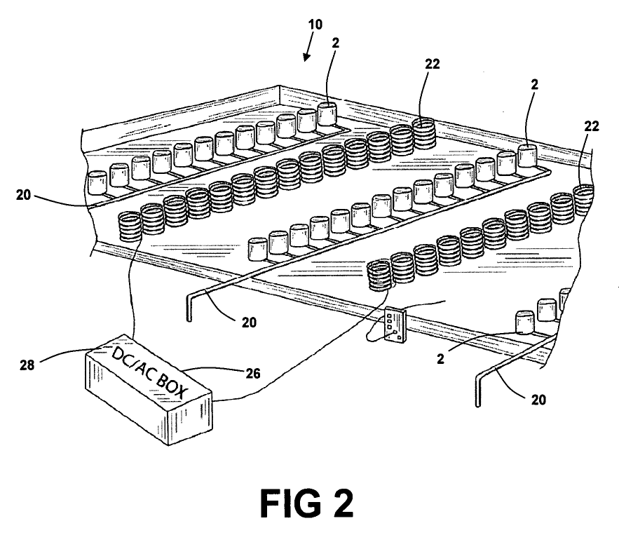

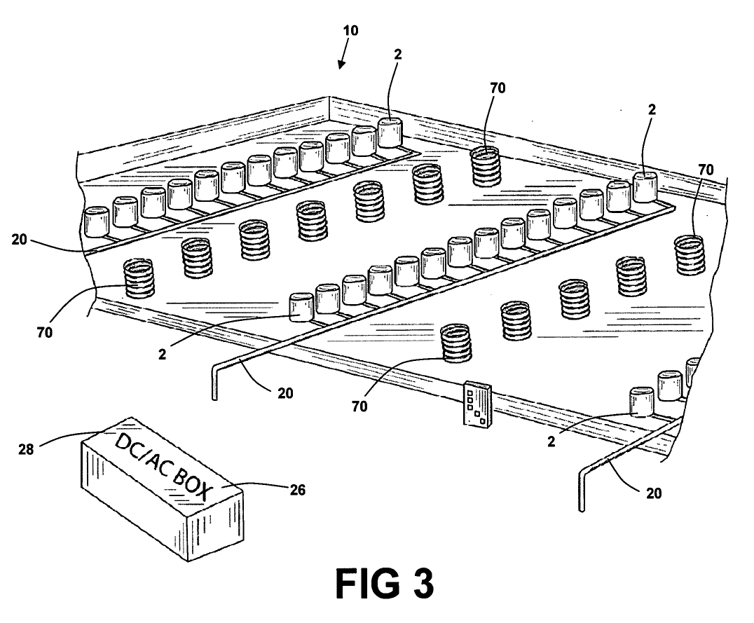

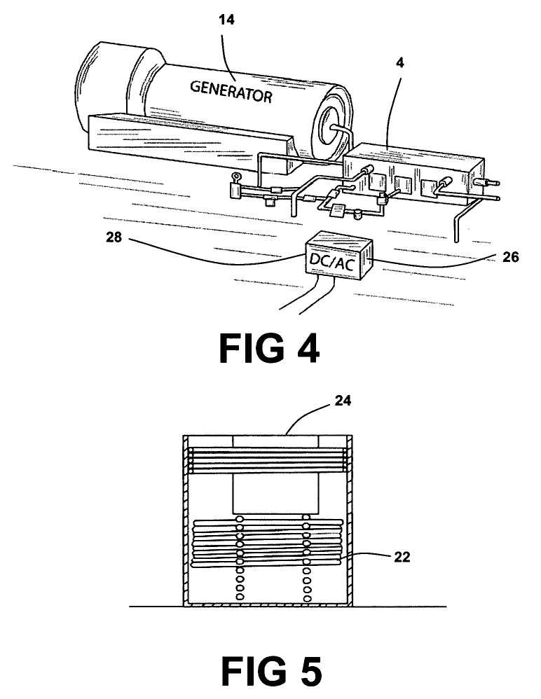

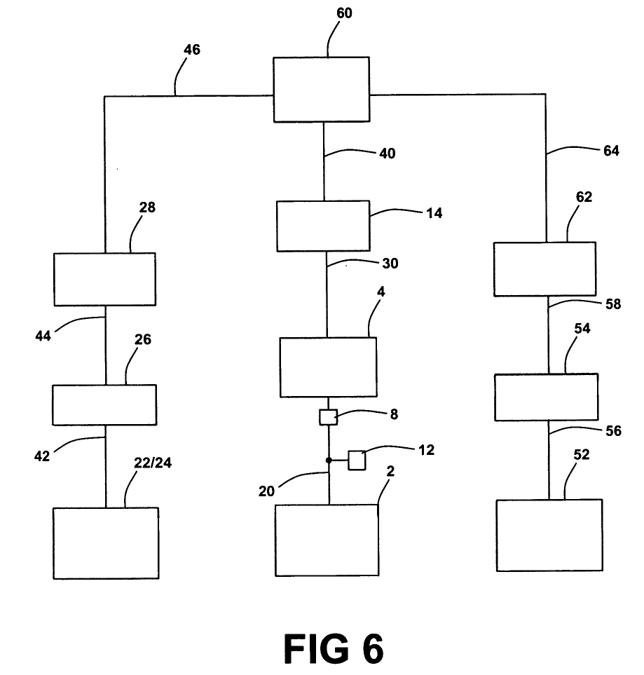

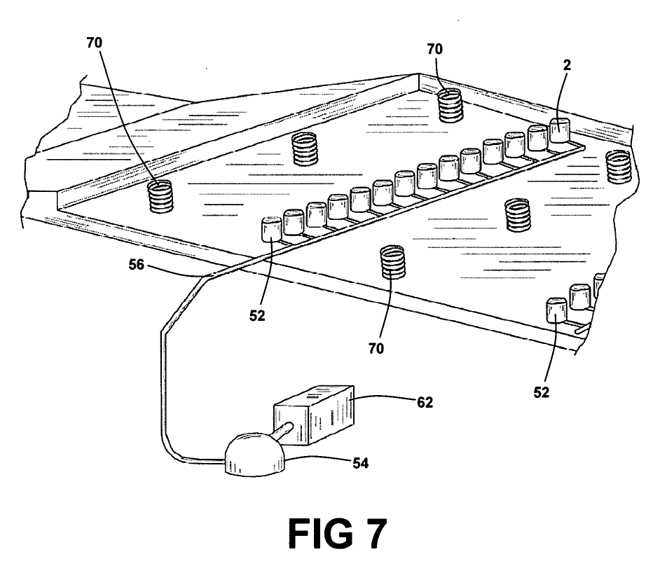

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for generating electrical energy as a vehicle traverses a predetermined section of a roadway. The apparatus 10 comprises a platform member 6 disposed over such predetermined section of roadway. A biasing means 70 is disposed between a top surface of such roadway and a bottom surface of the platform member 6 for returning the platform member 6 to a raised position after such vehicle has passed over the platform member 6. A plurality of coils 22 are engageable with and disposed in a predetermined pattern on an upper surface of such predetermined section of such roadway and are engageable with and disposed beneath the platform member 6. A plurality of magnets 24 are engageable with the bottom surface of the platform member 6, each magnet member 24 of such plurality of magnets 24 is disposed to pass through an interior portion of a respective one of each coil 22 of the plurality of coils 22 when the platform member 6 is depressed by such vehicle traversing the platform member 6 and rising up through the each coil 22 of such plurality of coils 22 when such vehicle has passed and the platform member 6 returns to its original position thereby creating an electrical charge. There is a DC storage unit 26 disposed closely adjacent the platform member 6 and has a first electrical connection 42 with the plurality of coils 22 for storing such DC current created by the plurality of magnets 24 passing through such plurality of coils 22. A DC to AC converter 28, having a second electrical connection 44 with the DC storage unit 26, is disposed closely adjacent the DC storage unit 26 for converting such DC current generated by the plurality of coils 22 and converting such DC current to AC current and a third electrical connection means 46 runs from the DC to AC converter 28 to a power distribution system 60 for delivering electrical power generated by the plurality of coils 22 to such power distribution system 60. It should be noted that such biasing means 70 is at least one of springs 70 and air bags 2. It is presently preferred that such biasing means 70 is a spring 70.

In an embodiment wherein air bags 2 are used as the biasing means 70 there would be a plurality of air bags 2. In this case the plurality of air bags 2 would be precharged at a pressure of 30 psi. Such precharging of the air bags 2 is used to force the platform to return to its original position after such vehicle has traversed the platform 6.

The apparatus 10 further includes front and rear ramps 32 so as to provide easy access to the platform member 6 and prevent any damage to the tires of such vehicles traversing the platform member 6. It should also be noted that the predetermined pattern of the coils 22 includes that the plurality of coils 22 are aligned in parallel rows across a width of such roadway. There are several rows of coils 22 under the platform member 6.

It is also preferred that such platform member 6 be formed of one of wire and metal frame. Such a predetermined length of such platform member is between about 20 and about 30 feet in length and such platform member is between about 9 and 11 feet in width.

In another embodiment of the invention such apparatus further includes a plurality of air bags 2 that are disposed on such upper surface of such roadway in a predetermined pattern so as to be compressed by such vehicle traversing the platform member 6.

A compressed air storage tank 4 is disposed closely adjacent such roadway and a first fluid communication means 20 is connected at a first end to each of the plurality of air bags 2 and at a second end to the compressed air storage tank 4 for communicating compressed air from the air bags 2 to the storage tank 4. The platform member 2 is disposed over the plurality of air bags 2 for such vehicle to pass over thereby causing the plurality of air bags 2 to be compressed and to communicate the air to the storage tank 4.

There is a first check valve means 8 disposed in the first fluid communication means 20. Such first check valve means 20 being open to the storage tank as such vehicle is compressing the platform member 6 and in a closed position when such vehicle has passed over the platform member 6. A second check valve means 12 is connected at a first end thereof to the first fluid communication means 20 and is disposed in fluid communication at a second end thereof to atmosphere such that the second check valve means 12 is in a closed position as such vehicle is traversing the platform member 6 and in an open position after such vehicle has passed over the platform member 6.

An electrical generator 14 is disposed closely adjacent the compressed air storage tank 4. A second fluid communication means 30 is connected at a first end thereof to the storage tank 4 and at a second end thereof to the electrical generator 14 for communicating sufficient air thereto to generate electrical power. A first connection 40 runs from the electrical generator 14 to a power distribution system 60 for delivering power generated by the electrical generator 14 to such power distribution system 60.

In a second aspect for providing a method for generating electricity by pneumatic means the present invention provides an apparatus, generally designated 10, for generating electrical energy as a vehicle traverses a predetermined section of a roadway. The apparatus 10 comprises a plurality of air bags 2 that are engageable with and disposed on an upper surface of such roadway in a predetermined pattern to be compressed by such vehicle. A compressed air storage tank 4 is disposed closely adjacent such roadway and a first fluid communication means 20 is connected at a first end to each of the plurality of air bags 2 and at a second end to the storage tank 4 for communicating compressed air from the air bags 2 to the storage tank 4.

A platform member 6 is engageable with and disposed over the plurality of air bags 2 for such vehicle to pass over thereby causing the plurality of air bags 2 to be compressed and communicate such compressed air to the storage tank 4. A biasing means 70 is disposed between such top surface of such roadway and a bottom surface of the platform member 6 to return such platform member to a raised position after such vehicle has passed over the platform member 6 and thereby allow the air bags 2 to return to a working position. A first check valve means 8 is disposed in the first fluid communication means 20, such first check valve means 8 being open to the storage tank 4 as such vehicle is compressing the platform member 6 and in a closed position when such vehicle has passed over the platform member 6. A second check valve member 12 is connected at a first end thereof to the first fluid communication means 20 and is disposed in fluid communication at a second end thereof to atmosphere such that the second check valve means 12 is in a closed position as such vehicle is traversing the platform member 6 and in an open position after such vehicle has passed over the platform member 6.

An electrical generator 14 is disposed closely adjacent the air storage tank 4 and a second fluid communication means 30 is connected at a first end thereof to the storage tank 4 and at a second end thereof to the electrical generator 14 for communicating sufficient air thereto to generate electrical power. There is a connection from the electrical generator 14 to a power distribution system 60 for delivering the power generated by the electrical generator 14 to such power distribution system 60.

In this embodiment it should be noted that such biasing means 70 is springs 70. Also such predetermined pattern includes that such plurality of air bags 2 are aligned in parallel rows across a width of such roadway and that there are at least two sets of parallel rows of such air bags 2.

In yet a third aspect of the present invention for providing a method of generating electricity by hydraulic means there is provided an apparatus 10 for generating electrical energy as a vehicle traverses a predetermined section of a roadway. The apparatus 10 comprises a plurality of hydraulic pumps 52 that are engageable with and disposed on an upper surface of such roadway in a predetermined pattern to be compressed by such vehicle. A hydraulic motor 54 is disposed closely adjacent such predetermined section of such roadway and a first hydraulic fluid communication means 56 is connected at a first end to each of the plurality of hydraulic pumps 52 and at a second end to the hydraulic motor 54 for communicating hydraulic fluid from the hydraulic pumps 52 to the hydraulic motor 54. A platform member 6 is disposed over the plurality of hydraulic pumps 52 for such vehicle to pass over thereby causing the plurality of hydraulic pumps 52 to be compressed and communicate the hydraulic fluid to the hydraulic motor 54. A biasing means 70 is disposed between such top surface of such roadway and a bottom surface of the platform member 6 for returning the platform member to a raised position after such vehicle has passed over the platform member 6 and thereby allow the hydraulic pumps 52 to return to a working position.

An electric generator 62 is disposed closely adjacent the hydraulic motor 56, wherein the hydraulic motor 56 forces such hydraulic fluid into the electric generator 62 while such vehicle is traversing the platform member 6 and stops after such vehicle has passed the platform member 6 and a spring disposed within the hydraulic motor 54 reverses the flow of such hydraulic fluid thereby refilling the hydraulic pumps 52. A second hydraulic fluid communication means 58 is connected at a first end thereof to the hydraulic motor 54 and at a second end thereof to the electric generator 62 for communicating the hydraulic fluid thereto for generating electrical power. There is an electrical connection means 64 from the electrical generator 62 to a power distribution system 60 for delivering power generated by the electrical generator 62 to such power distribution system 60. It should be noted that the biasing means 70 in this embodiment is springs 70. Thus, the present invention provides a simple and inexpensive new way to gather and use energy from an untapped yet easily accessible source. Vehicles that are currently in motion can create useable energy for use when, where and how it is needed. The apparatus simply rests on top of an existing road surface and when a vehicle passes over, the components of the invention harness and distribute the traffic-generated power as needed.

The apparatus features a platform that is placed directly atop of a road surface inviting vehicles to drive directly over the invention. The vehicles compress strategically placed hydraulic pumps or air bags. It is these pumps or bags that harness the generated energy, which can then be distributed anywhere. There is a beveled lipped platform, approximately six inches high, that can be made of wire or metal frame that is approximately 20 to 30 feet long by about 10 feet wide and made to sit directly on top of the original road surface. Beneath the platform section sits a predetermined number of hydraulic pumps, air bags or coils that with the weight of the vehicle crossing over, cause the connected air bags, hydraulic pumps to compress and then return to the original spring or air suspension supported, upright position. It is this compression and subsequent return to the original position that enables the generation of energy by the air bladders or pumps. Also in another embodiment magnets are made to pass through the coils when a vehicle passes the platform thereby also creating electrical energy. Each of the coils is connected to an underground wire, which is designed to run to the DC/AC box, which will then supply power to a generator. Also, along with the generators from the pneumatic or hydraulic means such system can be designed to distribute the seeming never-ending source of vehicle made energy to any location desired.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for generating electrical energy as a vehicle traverses a predetermined section of a roadway, said apparatus comprising:
(a) a platform member disposed over said predetermined section of roadway;
(b) a biasing means disposed between a top surface of such roadway and a bottom surface of said platform member for returning said platform member to a raised position after such vehicle has passed over said platform;
(c) a plurality of coils engageable with and disposed in a predetermined pattern on an upper surface of such predetermined section of such roadway are engageable with and disposed beneath said platform member;
(d) a plurality of magnets engageable with said bottom surface of said platform member, each magnet member of said plurality of magnets disposed to pass through an interior portion of a respective one of each coil of said plurality of coils when said platform member is depressed by such vehicle traversing said platform member and rising up through said each coil of said plurality of coils when such vehicle has passed and said platform member returns to its original position thereby creating an electrical charge;
(e) a DC storage unit disposed closely adjacent said platform member having a first electrical connection with said plurality of coils for storing such DC current created by said plurality of magnets passing through said plurality of coils;
(f) a DC to AC converter, having a second electrical connection with said DC storage unit, disposed closely adjacent said DC storage unit for converting such DC current generated by said plurality of coils and converting such DC current to AC current; and
(g) a third electrical connection means from said DC to AC converter to a power distribution system for delivering electrical power generated by said plurality of coils to such power distribution system.

2. The apparatus, according to claim 1, wherein said biasing means is at least one of springs and air bags.

3. The apparatus, according to claim 2, wherein said biasing means is springs.

4. The apparatus, according to claim 2, wherein said biasing means includes a plurality of air bags.

5. The apparatus, according to claim 4, wherein said plurality of air bags are precharged at 30 psi.

6. The apparatus, according to claim 4, wherein said precharging of said air bags is used to force said platform to return to its original position after such vehicle has traversed said platform.

7. The apparatus for generating electrical energy, according to claim 1, wherein said apparatus further includes front and rear ramps so as to provide easy access to said platform member and prevent damage to tires of such vehicles traversing said platform member.

8. The apparatus for generating electrical energy, according to claim 1, wherein said predetermined pattern includes said plurality of coils being aligned in parallel rows across a width of such roadway.

9. The apparatus for generating electrical energy, according to claim 1, wherein said platform member is formed of one of wire and metal frame.

10. The apparatus for generating electrical energy, according to claim 9, wherein said platform member is between about 20 and about 30 feet in length.

11. The apparatus for generating electrical energy, according to claim 1, wherein said platform member is between about 9 and 11 feet in width.

12. The apparatus, according to claim 1, wherein said apparatus further includes:
(a) a plurality of air bags disposed on such upper surface of such roadway in a predetermined pattern to be compressed by such vehicle;
(b) a compressed air storage tank disposed closely adjacent such roadway;
(c) a first fluid communication means connected at a first end to each of said plurality of air bags and at a second end to said storage tank for communicating compressed air from said air bags to said storage tank;
(d) said platform member disposed over said plurality of air bags for such vehicle to pass over thereby causing said plurality of air bags to be compressed and to communicate said air to said storage tank;
(e) a first check valve means disposed in said first fluid communication means, said first check valve means being open to said storage tank as such vehicle is compressing said platform member and in a closed position when such vehicle has passed over said platform member;
(f) a second check valve member connected at a first end thereof to said first fluid communication means and disposed in fluid communication at a second end thereof to atmosphere such that said second valve means is in a closed position as such vehicle is traversing said platform member and in an open position after such vehicle has passed over said platform member;
(g) an electrical generator disposed closely adjacent said air storage tank;
(h) a second fluid communication means connected at a first end thereof to said storage tank and at a second end thereof to said electrical generator for communicating sufficient air thereto to generate electrical power; and
(i) a connection from said electrical generator to a power distribution system for delivering power generated by said electrical generator to such power distribution system.

13. An apparatus for generating electrical energy as a vehicle traverses a predetermined section of a roadway, said apparatus comprising:
(a) a plurality of air bags engageable with and disposed on an upper surface of such roadway in a predetermined pattern to be compressed by such vehicle;
(b) a compressed air storage tank disposed closely adjacent such roadway;
(c) a first fluid communication means connected at a first end to each of said plurality of air bags and at a second end to said storage tank for communicating compressed air from said air bags to said storage tank;
(d) a platform member engageable with and disposed over said plurality of air bags for such vehicle to pass over thereby causing said plurality of air bags to be compressed and communicate said air to said storage tank;
(e) a biasing means disposed between such top surface of such roadway and a bottom surface of said platform member to return said platform member to a raised position after such vehicle has passed over said platform member and thereby allow said air bags to return to a working position;
(f) a first check valve means disposed in said first fluid communication means, said first check valve means being open to said storage tank as such vehicle is compressing said platform member and in a closed position when such vehicle has passed over said platform member;
(g) a second check valve member connected at a first end thereof to said first fluid communication means and disposed in fluid communication at a second end thereof to atmosphere such that said second valve means is in a closed position as such vehicle is traversing said platform member and in an open position after such vehicle has passed over said platform member;
(h) an electrical generator disposed closely adjacent said air storage tank;
(i) a second fluid communication means connected at a first end thereof to said storage tank and at a second end thereof to said electrical generator for communicating sufficient air thereto to generate electrical power; and
(j) a connection from said electrical generator to a power distribution system for delivering power generated by said electrical generator to such power distribution system.

14. The apparatus, according to claim 13, wherein said apparatus further includes:
(a) a plurality of coils engageable with and disposed in a predetermined pattern on an upper surface of such predetermined section of such roadway and beneath said platform member;
(b) a plurality of magnets engageable with a bottom surface of said platform member, each magnet member of said plurality of magnets disposed to pass through an interior portion of a respective one of each coil of said plurality of coils when said platform member is depressed by such vehicle traversing said platform member and rising up through said each coil of said plurality of coils when such vehicle has passed and said platform member returns to its original position thereby creating an electrical charge;
(c) a DC storage unit disposed closely adjacent said platform member having a first electrical connection with said plurality of coils for storing such electricity created by said plurality of magnets passing through said plurality of coils;
(d) a DC to AC converter, having a second electrical connection with said DC storage unit, disposed closely adjacent said DC storage unit for converting such DC electricity generated by said plurality of coils and converting such DC current to AC current; and
(e) a third electrical connection means from said DC to AC converter to a power distribution system for delivering electrical power generated by said plurality of coils to such power distribution system.

15. The apparatus, according to claim 13, wherein said biasing means is springs.

16. The apparatus for generating electrical energy, according to claim 13, wherein said apparatus further includes front and rear ramps so as to provide easy access to said platform member and prevent damage to tires of such vehicles traversing said platform member.

17. The apparatus for generating electrical energy, according to claim 13, wherein said predetermined pattern includes said plurality of air bags being aligned in parallel rows across a width of such roadway.

18. An apparatus for generating electrical energy as a vehicle traverses a predetermined section of a roadway, said apparatus comprising:
(a) a plurality of hydraulic pumps engageable with and disposed on an upper surface of such roadway in a predetermined pattern to be compressed by such vehicle;
(b) a hydraulic motor disposed closely adjacent said predetermined section of such roadway;
(c) a first hydraulic fluid communication means connected at a first end to each of said plurality of hydraulic pumps and at a second end to said hydraulic motor for communicating hydraulic fluid from said hydraulic pumps to said hydraulic motor;
(d) a platform member disposed over said plurality of hydraulic pumps for such vehicle to pass over thereby causing said plurality of hydraulic pumps to be compressed and communicate said hydraulic fluid to said hydraulic motor;
(e) a biasing means disposed between such top surface of such roadway and a bottom surface of said platform member for returning said platform member to a raised position after such vehicle has passed over said platform member and thereby allow said hydraulic pumps to return to a working position;
(f) an electric generator disposed closely adjacent said hydraulic motor, wherein said hydraulic motor forces said hydraulic fluid into said electric generator while such vehicle is traversing said platform member and stops after such vehicle has passed said platform member and a spring disposed within said hydraulic motor reverses a flow of such hydraulic fluid thereby filling said hydraulic pumps;
(g) a second hydraulic fluid communication means connected at a first end thereof to said hydraulic motor and at a second end thereof to said electric generator for communicating said hydraulic fluid thereto for generating electrical power;
(h) an electrical connection from said electrical generator to a power distribution system for delivering power generated by said electrical generator to such power distribution system.

19. The apparatus, according to claim 18, wherein said biasing means is springs.
